(19) United States
(12) Patent Application Publication
(10) Pub. No.: US 2017/0138761 A1
(43) Pub. Date: May 18, 2017

(54) RING MAGNETIC ENCODER, MANUFACTURING DEVICE FOR RING MAGNETIC ENCODER, ROTARY SHAFT OFFSET DETECTING METHOD, AND HUMAN-MACHINE INTERFACE DEVICE THEREOF

(71) Applicant: National Tsing Hua University, Hsinchu (TW)

(72) Inventors: Yu-Chen LIU, Hsinchu (TW); Jen-Yuan CHANG, Hsinchu (TW)

(21) Appl. No.: 15/133,212

(22) Filed: Apr. 19, 2016

(30) Foreign Application Priority Data
Nov. 18, 2015 (TW) 104137996

(51) Int. Cl. G01D 5/14

(52) U.S. Cl. CPC G01D 5/14

(57) ABSTRACT

A ring magnetic encoder includes a ring magnetic object and a ring code configured on the outside of the ring magnetic object. The ring magnetic object is divided into a first ring part and a second ring part. The ring code further includes a plurality of sector IDs, upper offset codes and lower offset codes. The sector IDs are configured on the outside of the ring magnetic object in fixed intervals. The upper offset codes and the lower offset codes are configured in the intervals respectively. The upper offset codes are configured on the first ring part, and the lower offset codes are configured on the second ring part. According to the upper offset codes and the lower offset codes, the offset of the rotary shaft during rotating can be detected for precisely positioning.

### BACKGROUND OF THE INVENTION

1. Field of the Invention

The present invention provides a ring magnetic encoder, a manufacturing device for generating ring magnetic encoder, a rotary shaft offset detecting method and a human-machine interface device. More particularly, the present invention provides the ring magnetic encoder for detecting the offset of the rotary shaft during rotating, the manufacturing device for ring magnetic encoder, the rotary shaft offset detecting method and the human-machine interface device.

2. Description of the Prior Art

The rotary encoder is also called as the axial encoder which is a specific device used in industry. The rotary encoder is used to transform the rotating location and the amount of the rotation of the rotary shaft into the digital signal or the analog signal for system to read. There are two kinds of the rotary encoders; one is an incremental encoder, and the other is an absolute encoder. Wherein, the absolute encoder gives the different parts of the rotary shaft a code to correspond to the interval and the part of the rotary shaft rotating to the pick-up head.

There are also two kinds of the absolute encoders. One is an optical absolute encoder, and the other is a mechanical absolute encoder. The optical absolute encoder comprises a circle plate rotating with the rotary shaft. There are a plurality of the concentric transparent intervals and the concentric opaque intervals. The combination of the concentric transparent intervals and the concentric opaque intervals generates different optical characteristics on the circle plate to get the location of the rotary shaft by measuring the optical array. Although the optical absolute encoder is precise, it loses the utility and precision in a bad environment because its anti-environment ability is not that good.

Compared to it, the mechanical absolute encoder, especially the magnetic encoder, has high anti-environment ability. The magnetic encoder is able to be a circle magnet. The magnetic encoder surrounds the rotary shaft and sets the codes on the surface of the ring magnetic object. The codes are the binary codes made by utilizing the S-pole and N-pole. The codes are configured on the different locations of the rotary shaft. Then, the Hall effect sensor or the magneto resistance effect sensor is used for detection.

The magnetic encoder mentioned above is able to detect locations, intervals, angles, the amount of the rotation and velocities. But the magnetic encoder mentioned above is unable to detect the axial offset of the rotary shaft. Please refer to FIG. 1; FIG. 1 shows a diagram of a magnetic encoder locating a rotary shaft which is applied in the prior arts. The magnetic encoder 10 is set on the rotary shaft 2 and has the same axial with the rotary shaft 2. The pick-up head 12, like the Hall effect sensor, is disposed on the lateral side of the magnetic encoder 10 to read the codes on the magnetic encoder 10. When the rotary shaft 10 rotates clockwise or counterclockwise, the location, the interval, the angle, the amount of the rotation of the rotary shaft 12 can be located according to the information read by the pick-up head 12. However, the axial of the rotary shaft 10 may not be as same as the rotating axial, so the offset is generated. The offset makes the rotary shaft 10 and the magnetic encoder 10 generate another offset when they are rotating. The offset also makes the locating inaccurate. To a specific instrument, the offset and inaccurate locating are able to damage the instrument.

Therefore, it is necessary to invent a magnetic encoder for detecting the offset of the rotary shaft during rotating to solve the problem mentioned above.

### SUMMARY OF THE INVENTION

A scope of the present invention provides a ring magnetic encoder. According to an embodiment, the ring magnetic encoder comprises a ring magnetic object and a ring code configured on the outside of the ring magnetic object. The ring magnetic object is divided into a first ring part and a second part by a ring central line. The ring code further includes a plurality of sector IDs, upper offset codes, and lower offset codes. The sector IDs are configured on the outside of the ring magnetic object in fixed intervals. The upper offset codes and the lower offset codes are configured in the intervals respectively.

In the embodiment, every sector ID is used to identify the different location of the rotary shaft, and the upper offset codes and the lower offset codes which are set between two sector IDs are respectively configured on the first ring part and the second ring part to let the pick-up head get the offset signal and adjust the axis offset of the rotary shaft.

Another scope of the present invention provides a manufacturing device for the ring magnetic encoder. The manufacturing device for the ring magnetic encoder is able to generate the ring magnetic encoder to detect and adjust the axis offset of the rotary shaft. According to an embodiment, the manufacturing device for ring magnetic encoder comprises a rotating plate and a coding module. The rotating plate is used for loading and rotating the ring magnetic object. The coding module is disposed on the lateral surface of the rotating plate to input the code into the ring magnetic object for generating the ring magnetic encoder. The coding module comprises a permanent magnet, a magnet charger which is close to the permanent magnet and an adjustment unit which is used for connecting to the location of the magnet charge. The magnet charger is able to set the sector IDs, the upper offset codes and the lower offset codes on the different location of the outside of the ring magnetic object by the location adjustment unit.

Another scope of the present invention provides a rotary shaft offset detecting method for detecting the axis offset of the rotary shaft. According to an embodiment, the rotary shaft offset detecting method comprising the following steps of: setting a ring magnetic encoder on the rotary shaft having the sector IDs, the upper offset codes and the lower offset codes; utilizing the pick-up head to read the sector IDs, the upper offset codes and the lower offset codes when the rotary shaft rotates; and calculating an offset of the rotary shaft according to the sector IDs, the upper offset codes and the lower offset codes.

Another scope of the present invention provides a human-machine interface device for controlling the manufacturing device for the ring magnetic encoder to generate the ring magnetic encoder. According to an embodiment, the human-machine interface device of the present invention comprises a display unit, a data processing unit and an input unit. The data processing unit connects to the display unit and the input unit. The data processing unit is able to further connect to the manufacturing device for the ring magnetic encoder. The data processing unit is able to control the display unit to display a human-machine interface. The human-machine interface has a first object which is corresponding to a location of a magnet charger of the generating device for the ring magnetic encoder. The user can input a parameter to the first object of the human-machine interface to control the location of the magnet charger of the manufacturing device for ring magnetic encoder by the input unit. And then the ring magnetic encoder is able be generated on the different location of the ring magnetic object.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows the diagram of a magnetic encoder locating a rotary shaft which is applied in the prior arts.

FIG. 2A shows the diagram of the ring magnetic encoder of the present invention in an embodiment.

FIG. 2B and FIG. 2C show a diagram of the ring magnetic encoder shown in FIG. 2A rotating with the rotary shaft.

FIG. 3 shows the flow chart of a rotary shaft offset detecting method of the present invention in an embodiment.

FIG. 4 shows a diagram of a manufacturing device for the ring magnetic encoder of the present invention in an embodiment.

FIG. 5A shows a functional block diagram of the human-machine interface device of the present invention in an embodiment.

FIG. 5B shows a diagram of the human-machine interface displayed by the display unit show in FIG. 5A.

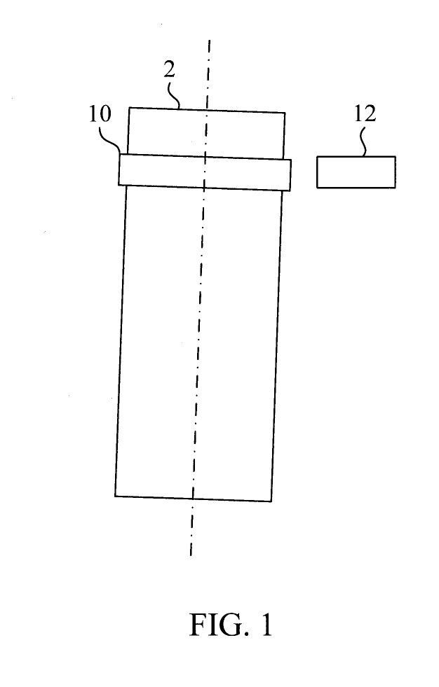

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

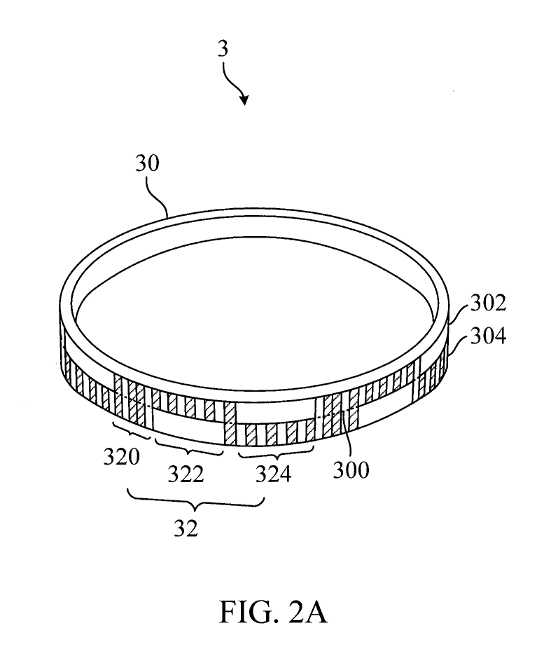

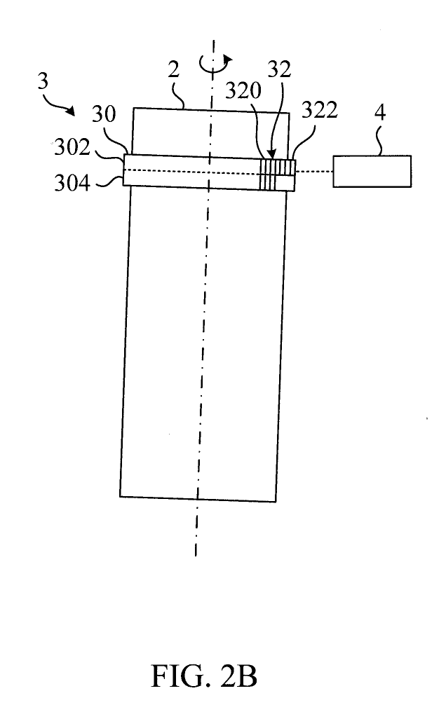

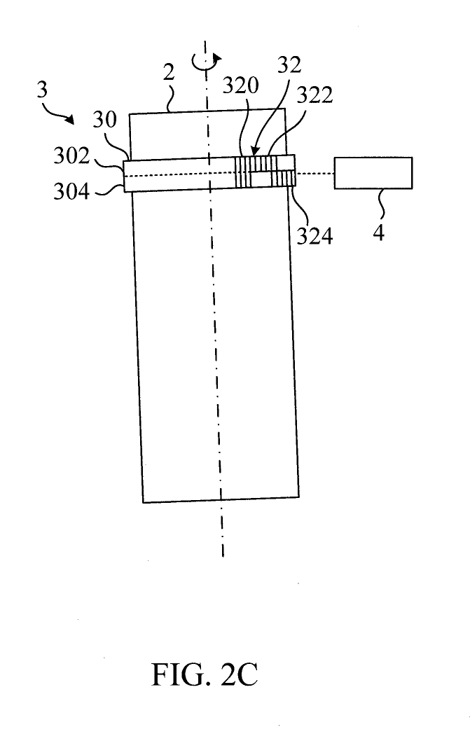

Please refer to FIG. 2A. FIG. 2A shows the diagram of the ring magnetic encoder of the present invention in an embodiment. The ring magnetic encoder 3 comprises a ring magnetic object 30 and a ring code 32 disposed on the outside of the ring magnetic object 30. In practice, the ring magnetic object 30 is able to be made of the magnetic material. Part of the ring magnetic object 30 is magnetized by the poles. Besides, the poles disposed on the ring magnetic object 30 generate the codes. The codes are able to be detected by the pick-up head when the ring magnetic encoder 3 is rotating with the rotary shaft.

The ring magnetic object 30 is divided into two parts by the ring central line 300. The two parts are the first ring part 302 and the second ring part 304. In the embodiment, the ring central line 300 is not a real structure but a imagine structure used to divide the ring magnetic object 30 into the first ring part 302 and the second ring part 304. The first ring part 302 and the second ring part 304 are two ring structures with same size and piled with each other. When the ring magnetic object 30 is disposed on a rotary shaft, the first ring part 302 and the second ring part 304 are respectively disposed on the different locations of the axis of the rotary shaft.

The ring code 32 disposed on the outside of the ring magnetic object 30 comprises a plurality of sector IDs 320, a plurality of upper offset codes 322 and a plurality of lower offset codes 3240. The sector IDs 320 are configured on the outside of the ring magnetic object 30 with a fixed interval. The sector IDs are used to mark the different locations and intervals of the rotary shaft. For example, the ring code 32 which comprises eight sector IDs 320 and is also respectively disposed on the outside of the ring magnetic object 30 shows that the ring magnetic encoder 3 is able to divide the rotary shaft into eight pieces through the radial direction, and every sector ID 320 presents one of the eight pieces of the rotary shaft. That is to say, when the rotary shaft rotates one of the sector IDs 320, such as the first sector ID, through the pick-up head, the pick-up head reads the first sector ID to get the location and the interval of the first sector ID on the rotary shaft. According to the every sector ID 320, the user can get the rotating angle, the location, the interval, the rotating velocity and the amount of rotation of the rotary shaft.

A plurality of upper offset codes 322 and a plurality of lower offset codes 324 are respectively configured between two sector IDs 320. That is to say, a sector ID 320 are able to be disposed by an upper offset code 322 and a lower offset code 324. Depending on the sector ID 320, the upper offset code 322 and the lower offset code 324 are configured on the corresponding interval of the rotary shaft. Moreover, the upper offset codes 322 are configured on the first ring part 302, and the lower offset codes 324 are configured on the second ring part 304. The sector IDs 320, the upper offset codes 322, and the lower offset codes 324 of the ring code 32 are set by N-poles and S-poles. Therefore, the pick-up head can get the magnetic flux density when it reads the ring code 32. When the axial center is not disposed at the predetermined axial center, the rotary shaft generates the axial offset when it is rotating. However, in the embodiment, the axial offset of the rotary shaft is able to be adjusted and detected by utilizing the upper offset codes 322 and the lower offset codes 324.

Please refer to FIG. 2B and FIG. 2C. FIG. 2B and FIG. 2C show a diagram of the ring magnetic encoder shown in FIG. 2A rotating with the rotary shaft. The ring magnetic object 30 of the ring magnetic encoder 3 is disposed on the rotary shaft 2. The ring magnetic encoder 3 has a pick-up head 4 to read the ring code 32. The pick-up head 4 is disposed at the central line of the ring encoder 3. When the axial center of the rotary shaft 2 is remained at the predetermined location, the pick-up head 4 can read the sector IDs 320. When the rotary shaft 2 generates the axial offset, the upper offset codes 322 and the lower offset codes 324 get the offset what makes the pick-up head 4 read the change of the magnetism.

That is to say, when the axial center of the rotary shaft 2 is not disposed at the predetermined location and moves to the location shown on FIG. 2B, the ring magnetic encoder 3 leans, which makes the offset of the upper offset codes 322 of the pick-up head 4 move downwards so that the change of the magnetism is read by the pick-up head 4. On the other hand, when the rotary shaft 2 moves to the location shown on FIG. 2C, the ring magnetic encoder 3 leans to the opposite side, which makes to the offset of lower offset codes 324 move upwards so that the pick-up head 4 can read the change of the magnetism.

When the axial offset of the rotary shaft 2 makes the upper offset codes 322 and the lower offset codes 324 move, the density of the magnetism read by the pick-up head 4 is decreased. Also, since every code is generated by the plurality of N-poles and S-poles, the density of the magnetism of the upper offset codes 322 and the lower offset codes 324 has a plurality of peaks. The axial offset which is chosen to present the sector ID 320 of the rotary shaft 2 is determined by the position error signal, PES. And PES is able to be calculated by the peak of the density of the magnetism of the upper offset codes 322 and the lower offset codes.

PES=(A−B)/(A+B);

Wherein A is the total sum of the absolute values of the difference between the every peak and the average peak of the density of the magnetism gotten from reading the upper offset codes 322; B is the total sum of the absolute values of the difference between the every peak and the average peak of the density of the magnetism gotten by reading the lower offset codes 324.

In practice, the PES and the axial offset are linearly related when axial offset ranges from −0.5 mm to 0.5 mm. That is to say, PES is accurate when axial offset ranges from −0.5 mm to 0.5 mm. To those precise devices, the axial offset or other different errors is contained in the axial offset mentioned above. That is to say, the PES values corresponding to the axial offset ranges from −0.5 mm to 0.5 mm are able to present the axial offset of the rotary shaft.

To summarize, the location, the angle, the rotating velocity and the amount of the rotation can be known by the sector IDs of the ring magnetic encoder. Moreover, by the axial offset of every interval of the rotary shaft of the upper offset codes and the lower offset codes, the ring magnetic encoder can locate the rotary shaft accurately.

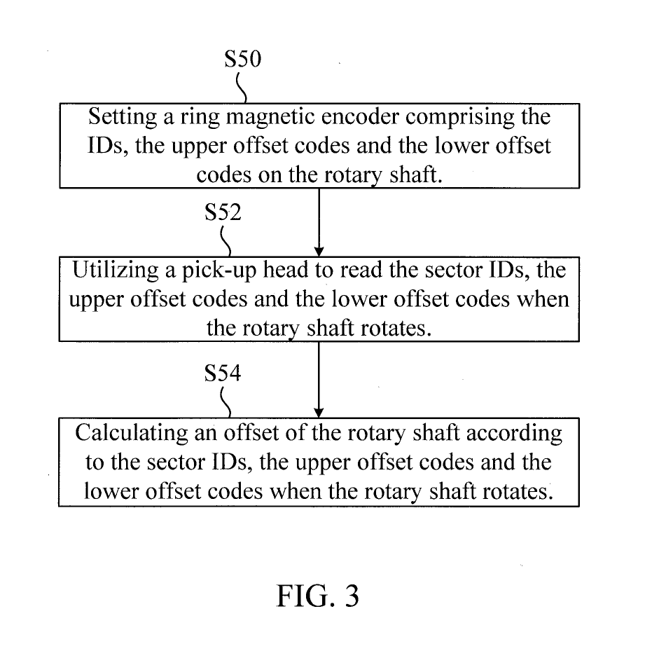

Please refer to FIG. 3. FIG. 3 shows the flow chart of a rotary shaft offset detecting method of the present invention in an embodiment. Also, please refer to FIG. 2A to FIG. 2C for more explanations because the embodiment is the same.

The rotary shaft offset detecting method comprises the following steps of: setting a ring magnetic encoder 3 on the rotary shaft 2, the ring magnetic encoder 3 comprising a plurality of sector IDs 320 disposed with a fixed interval, a plurality of upper offset codes 322 disposed among the sector IDs 320 on the first ring part and a plurality of lower offset codes 324 disposed among the sector IDs 320 on the first ring part in S50; utilizing a pick-up head 4 to read the sector IDs 320, the upper offset codes 322 and the lower offset codes 324 when the rotary shaft 2 rotates in S52; and calculating an offset of the rotary shaft according to the sector IDs 320, the upper offset codes 322 and the lower offset codes 324 in S54.

In S50, the ring magnetic encoder 3 is slipped on the rotary shaft 2, so the axial center of the ring magnetic encoder 3 is the same as the rotary shaft 2. Besides, the second ring part 304 of the ring magnetic encoder 3 is slipped on the rotary shaft first, and then the first ring part 302 of the ring magnetic encoder 3 is slipped on the rotary shaft after the first ring part 302 and the upper offset codes 322 are closer to the top of the rotary shaft 2. But the present invention is not limited to it. The first ring part 302 of the ring magnetic encoder 3 is also able to be slipped on the rotary shaft 2 first. The different sequence does not affect the detection of the axial offset too much.

In S52, the sector IDs 322 read by the pick-up head 4 is used to locate the intervals of the rotary shaft 2. The upper offset codes 322 and the lower offset codes 324 are read for getting the information of the axial offset of the every interval of the rotary shaft 2. In S54, the pick-up head 4 calculates the axial offset according to the upper offset codes 322 and the lower offset codes 324 when the rotary shaft 2 rotates. The method about how to calculate the axial offset is already mentioned above.

Therefore, the rotary shaft offset detecting method of the present invention is about utilizing the ring magnetic encoder to locate the location, the interval, the angle, the velocity and the amount of the rotation and detect and adjust the axial offset of the rotary shaft.

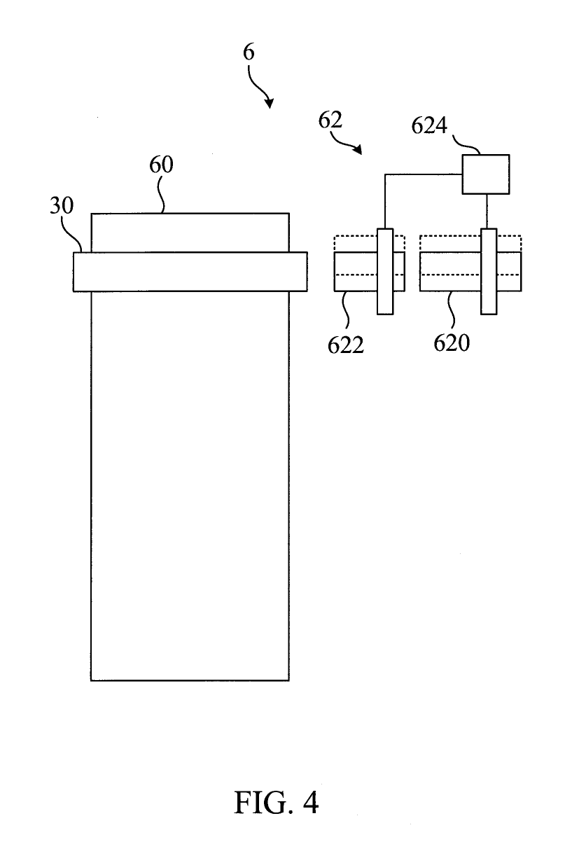

Please refer to FIG. 4. FIG. 4 shows a diagram of a manufacturing device for ring magnetic encoder of the present invention in an embodiment. The manufacturing device for ring magnetic encoder 6 of the present invention is used to generate the ring magnetic encoder. Please refer to FIG. 4; the manufacturing device for ring magnetic encoder 6 comprising the rotating plate 60 and the coding module 62, wherein the rotating plate 60 is used to load the ring magnetic object 30 of the ring magnetic encoder 3. The coding module 62 is disposed on the lateral side of the rotating plate 60 and is close to the ring magnetic object 30 to write the codes on the outside of the ring magnetic object 30.

The ring magnetic object 30 is able to be shipped on the rotating plate 60 to let the rotating plate 60 move the ring magnetic object 30 to rotate in the same axial center. However, the present invention is not limited to it. Any structure which can help the rotating plate 60 move the ring magnetic object 30 to rotate is able to be the rotating plate of the present invention.

The coding module 62 can further comprises a permanent magnet 620, a magnet charger 622 and a location adjustment unit 624. Wherein the magnet charger 622 is able to receive the magnetism of the permanent magnet 620 to charge the ring magnetic object with magnetism. That is to say, the magnet charger 622 is able to be silicon steel. The silicon steel is a rectangular slice. When the first side of the magnet charger gets close to a pole of the permanent magnet 620, the first side of the magnet charger 622 generates the opposite pole, and the first side and the second side of the magnet charger 622 is able to interact with each other to generate the same pole. Moreover, when the ring magnetic object 30 is close to the second side of the magnet charger 620, the pole of the permanent magnet 620 which is close to the first side of the magnet charger 622 shows the opposite pole. For example, if the first side of the magnet charger 622 gets close to the N-pole of the permanent magnet 620, the code written by the second side of the magnet charger 622 on the magnetic object 30 is S-pole. When the ring magnetic object 30 writes the codes on the specific location, the rotating plate 60 moves ring magnetic object 30 to rotate to the next location to write in next codes. Besides, if the pole of the codes is different from the last one, the stepping motor or other rotating plate rotates the permanent magnet 620 directly to make another pole close to the first side of the magnet charger 622.

Besides, the magnet charger 622 is silicon steel. The second side of the silicon steel is a rectangular slice to make the magnetism gather on the two edges of the rectangular. Because the magnetism is gathered, the width of the codes is wider than that of the user's expectation. Therefore, the edge of the code with the opposite pole interacts with the part of the magnetism of the last code to control the width of the code while writing the code with different poles.

The location adjustment unit 624 is connected to the magnet charger 622 and the permanent magnet 620 to make this two parts move along with the direction parallel with the axle center of the ring magnetic object 30. In practice, the location adjustment unit 624 is not limited to it. The location adjustment unit is able to be the stepping motor or the three-axis platform. The permanent magnet 620 and the magnet charger 622 are able to be in the different location by the location adjustment unit 624, shown in FIG. 4, to put the code on the different parts of the ring magnetic object 30. For example, if the magnet charger 622 is adjusted to face the ring central line of the ring magnetic object 30 through the location adjustment unit 624, the magnet charger 622 is able to write the sector IDs on the ring magnetic object 3. If the magnet charger 622 is adjusted to face the first ring part of the ring magnetic object 30 by the location adjustment unit 624, the upper offset codes are written on the ring magnetic object 30. If the magnet charger 622 is adjusted to face the second ring part of the ring magnetic object 30 by the location adjustment unit 624, the lower offset codes are written on the ring magnetic object 30.

Therefore, the manufacturing device for ring magnetic encoder 6 of the present invention in the embodiment is able to generate the ring magnetic encoder 3 which is used for locating the rotation of the rotary shaft and detecting the axial offset.

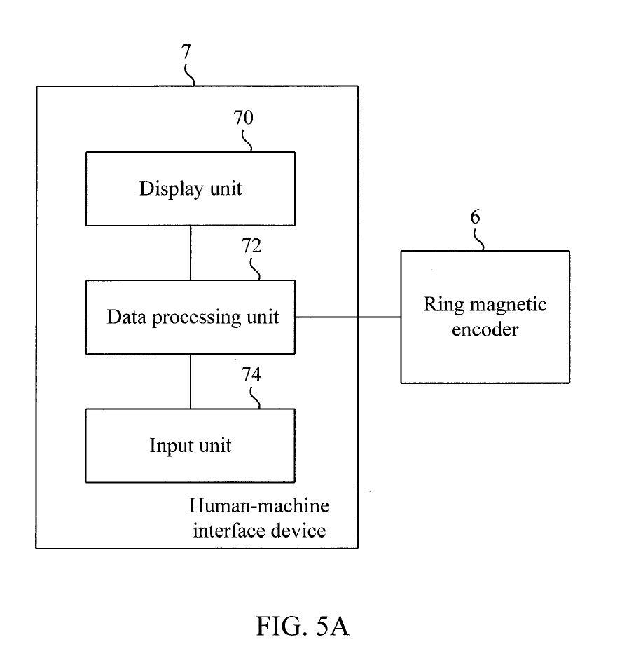

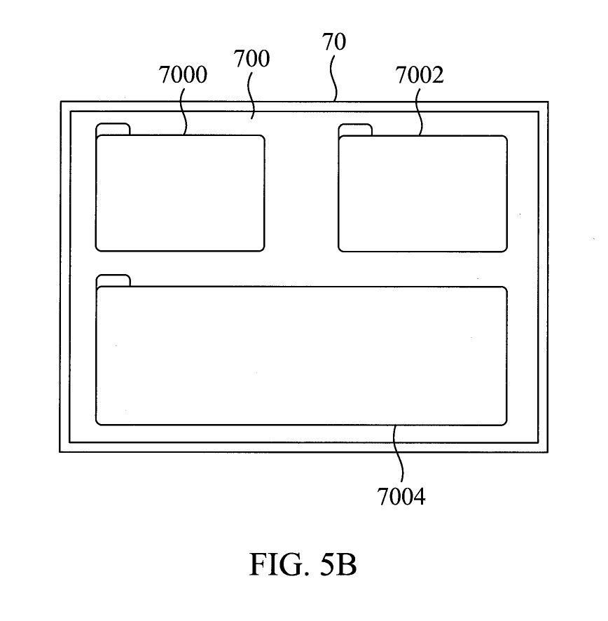

The manufacturing device for ring magnetic encoder mentioned above is able to be controlled by the human-machine interface device when the manufacturing device for ring magnetic encoder is used. Please refer to FIG. 5A. FIG. 5A shows a functional block diagram of the human-machine interface device of the present invention in an embodiment. The human-machine interface device 7 in the embodiment is able to be used for controlling the manufacturing device for ring magnetic encoder 6 mentioned in the embodiments to generate the ring magnetic encoder. The human-machine interface device 7 can comprises a display unit 70, a data processing unit 72 and an input unit 74. Wherein the data processing unit 72 can be connected to the display unit 70, the input unit 74 and the manufacturing device for the ring magnetic encoder 6. The data processing unit 72 can control the display unit 70 to display the human-machine interface for users to do the operation according to the human-machine interface. Besides, the user can input the parameters into the objects of the human-machine interface. The data processing unit 72 generates the indication according to the parameters to control the location of the magnet charger of the manufacturing device for ring magnetic encoder 6 to generate the ring code.

The location of the magnet charger mentioned above is not limited to it. The user can input the different parameters into the human-machine interface to get the different ring code. Please refer to FIG. 5B. FIG. 5B shows a diagram of the human-machine interface 700 displayed by the display unit 70 shown in FIG. 5A. The human-machine interface 700 can comprise a plurality of different objects like the first object 7000 which is corresponding to the location of the magnet charger, the second object 7002 which is corresponding to the angular deflection of the permanent magnet and the third object 7004 which is corresponding to the rotating plate rotating around the manufacturing device for ring magnetic encoder. By inputting the parameters into the objects, the manufacturing device for ring magnetic encoder is able to be controlled to generate the ring magnetic encoder.

The human-machine interface device 7 mentioned above is not limited to a laptop, a computer, a notebook or a smart phone. The display unit 70 is able to be any display panel. The data processing unit 72 is able to be the central processing unit. The input unit is able to be a keyboard, a mouse, a touch screen or a sound controlled screen.

To summarize, the ring magnetic encoder of the present invention comprises the upper offset codes and the lower offset codes to locate the rotation of the rotary shaft, and detect and adjust the axial offset of the rotary shaft to solve the problems from prior arts to get a precise location of the rotary shaft. Besides, the present invention further provides the manufacturing device for the ring magnetic encoder, the human-machine interface device and the rotary shaft offset detecting method.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A ring magnetic encoder, comprising:
a ring magnetic object, comprising a first ring part and a second ring part; and
a ring code, configured on the outside of the ring magnetic object, the ring code comprising:
a plurality of sector IDs, configured on the ring magnetic object in fixed intervals;
a plurality of upper offset codes, respectively configured in the intervals between the sector IDs, the upper offset codes configured on the first ring part of the ring magnetic object; and
a plurality of lower offset codes, configured in the intervals among the sector IDs and staggered with the upper offset codes, the lower offset codes configured on the second ring part of the ring magnetic object.

2. The ring magnetic coder of claim 1, wherein the sector IDs, the upper offset codes and lower offset codes comprise a plurality of N-poles and S-poles respectively in a specific sequence.

3. A manufacturing device for a ring magnetic encoder, for generating a code graphic on the outside of a ring magnetic object to generate the ring magnetic encoder, the manufacturing device for the ring magnetic encoder comprising:
a rotating plate, for loading and rotating the ring magnetic object; and
a coding module, disposed on the lateral surface of the rotating plate, the coding module further comprising:
a permanent magnet;
a magnet charger, one side of the permanent magnet to be close to the permanent magnet for receiving the magnetism of the permanent magnet, the other side to be close to the outside of the ring magnetic object for charging the ring magnetic object with magnetism; and
a location adjustment unit, connected to the magnet charger and the permanent magnet for driving the magnet charger and permanent magnet to move along with a direction parallel to a rotating axis of the ring magnetic object;
wherein the direction is vertical to the rotating direction of the ring magnetic object, the magnet charger adjusts a location according to the location adjustment unit to recharge the outside of the ring magnetic object with magnetism to form a sector ID, an upper offset code and a lower offset code.

4. The manufacturing device for the ring magnetic encoder of claim 3, wherein the magnet charger is a silicon steel, the silicon steel is a rectangular slice comprising a first side to be close to the permanent magnet and a second side to be close to the outside of the ring magnetic object.

5. The manufacturing device for the ring magnetic encoder of claim 3, wherein the ring magnetic object is divided into a first ring part and a second ring part by a ring central line; the magnet charger moves to the first ring part by the location adjustment unit to recharge the first ring part with magnetism to generate the upper offset code on the first ring part; the magnet charger moves to the second ring part to recharge the first ring part with magnetism to generate the lower offset code on the second ring part; and when the magnet charger moves to the ring central line to recharge the ring magnetic object with magnetism to generate the sector ID on the ring magnetic object.

6. The manufacturing device for the ring magnetic encoder of claim 3, wherein the permanent magnet is able to rotate in-place, the permanent magnet comprises a N-pole and a S-pole, wherein one of the N-pole and the S-pole is able to close to the magnet charger by rotating.

7. A rotary shaft offset detecting method, for detecting an axis offset when a rotary shaft rotates, comprising the following steps of:
setting a ring magnetic encoder on the rotary shaft, the ring magnetic encoder divided into a first ring part and a second ring part by the ring central line, the outside of the ring magnetic encoder comprising a plurality of sector IDs disposed with a fixed interval, a plurality of upper offset codes disposed among the sector IDs on the first ring part and a plurality of lower offset codes disposed among the sector IDs on the first ring part;
utilizing a pick-up head to read the sector IDs, the upper offset codes and the lower offset codes when the rotary shaft rotates; and
calculating an offset of the rotary shaft according to the sector IDs, the upper offset codes and the lower offset codes.

8. The rotary shaft offset detecting method of claim 7, further comprising the following steps of:
calculating a rotating velocity of the rotary shaft and the interval of the pick-up head rotating across the rotary shaft according to the sector IDs, the upper offset codes and the lower offset codes.

9. A human-machine interface device, for controlling a the manufacturing device for a ring magnetic encoder to recharge a ring magnetic object with magnetism to generate the ring magnetic encoder, the human-machine interface device comprising:
a display unit;
a data processing unit, connected to the display unit and the manufacturing device for the ring magnetic encoder, the data processing unit controlling the display unit to display a human-machine interface, the human-machine interface comprising a first object corresponding to a location of a magnet charger of the manufacturing device for the ring magnetic encoder; and
an input unit, connected to the data processing unit, for a user to input a parameter to the first object of the human-machine interface;
wherein the data processing unit receives the parameter according to the human-machine interface to generate a controlling order to the magnet charger of the manufacturing device for the ring magnetic encoder to control the location of the magnet charger.

10. The human-machine interface device of claim 9, wherein the human-machine interface further comprises a second object corresponding to the spinning of a permanent magnet of the manufacturing device for the ring magnetic encoder and a third object corresponding to the spinning of a rotating plate of the manufacturing device for the ring magnetic encoder.
